(19) United States
(12) Patent Application Publication
(10) Pub. No.: US 2026/0246814 A1
(43) Pub. Date: Aug. 20, 2026

(54) DYNAMIC IOT CONNECTION RISK MANAGEMENT ON NETWORK SLICES

(71) Applicant: INTERNATIONAL BUSINESS MACHINES CORPORATION, ARMONK, NY (US)

(72) Inventors: Jessica Nahulan, Vaughan (CA); Heather Nicole Polgrean, Lagrangeville, NY (US); Tiberiu Suto, Franklin, NY (US); Jeremy R. Fox, Georgetown, TX (US)

(21) Appl. No.: 19/055,647

(22) Filed: Feb. 18, 2025

(51) Int. Cl. H04L 9/40

(52) U.S. Cl. CPC H04L 63/20; H04L 63/1425

(57) ABSTRACT

Described are techniques for network slice management. A computer-implemented method may connect a first device to a network slice. The computer-implemented method may segment data transmitted from the first device into distinct security categories, where the distinct security categories are assigned to a specific corresponding network slice that supports an associated security category. The computer-implemented method may, in response to a request for inter-slice communication between the first device and a second device on a different network slice, transfer the second device on the different network slice to the network slice.

### BACKGROUND

The present disclosure relates to cybersecurity, and, more specifically, to Internet of Things (IoT) risk management on network slices.

5G is the fifth generation of cellular network technology, succeeding 4G. 5G enables a new kind of network that is designed to connect virtually everyone and everything together including machines, objects, and devices.

### SUMMARY

In some aspects, the techniques described herein relate to a computer-implemented method that comprises connecting a first device to a network slice. The computer-implemented method further comprises segmenting data transmitted from the first device into distinct security categories, where the distinct security categories are assigned to a specific corresponding network slice that supports an associated security category. The computer-implemented method further comprises, in response to a request for inter-slice communication between the first device and a second device on a different network slice, transferring the second device on the different network slice to the network slice.

In additional aspects, the techniques described herein relate to a computer-implemented method that comprises connecting a first device to a network slice. The computer-implemented method further comprises intermittently updating slice configurations and security policies of the network slice based on threat intelligence and network demands. The computer-implemented method further comprises determining that the first device does not comply with the intermittently updated slice configurations and security policies of the network slice. The computer-implemented method further comprises reassigning the first device to a second network slice that is compliant with the intermittently updated slice configurations and security policies of the second network slice. The computer-implemented method further comprises logging slice changes of the first device on a blockchain.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example computational environment for network slice management, in accordance with some embodiments of the present disclosure.

FIG. 2 illustrates a flowchart of an example method for inter-slice communication and network slice management, in accordance with some embodiments of the present disclosure.

FIG. 3 illustrates a flowchart of an example method for inter-slice migration and network slice management, in accordance with some embodiments of the present disclosure.

FIG. 4 illustrates a flowchart of an example method for downloading, deploying, metering usage, and invoicing network slice security code, in accordance with some embodiments of the present disclosure.

FIG. 5 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward cybersecurity, and, more specifically, to Internet of Things (IoT) risk management on network slices. While not limited to such applications, embodiments of the present disclosure may be better understood in light of the aforementioned context.

In a first aspect, a computer-implemented method is provided. The computer-implemented method includes connecting a first device to a network slice, segmenting data transmitted from the first device into distinct security categories, wherein the distinct security categories are assigned to a specific corresponding network slice that supports an associated security category, and in response to a request for inter-slice communication between the first device and a second device on a different network slice, transferring the second device on the different network slice to the network slice.

This method enables efficient and secure communication between devices on different network slices while maintaining appropriate security levels for different types of data. By transferring devices to the same slice for communication, the method reduces potential security risks associated with inter-slice communication.

The computer-implemented method may further include implementing a cryptocurrency smart contract of a data payload with an associated valuation between the first device and the second device.

Implementing cryptocurrency smart contracts for data payloads provides a secure and transparent method for managing data transactions between devices, potentially incentivizing secure data sharing and transfer within the network.

The computer-implemented method may connect the first device to the network slice that satisfies a bandwidth, latency, and security level requirement derived from device characteristics of the first device.

By matching device characteristics with appropriate network slice capabilities, this feature ensures improved performance and security for each connected device, enhancing overall network efficiency and user experience.

The computer-implemented method may further include intermittently updating slice configurations and security policies of the network slice based on threat intelligence and network demands.

Regular updates to slice configurations and security policies allow the network to adapt to evolving threats and changing network conditions, maintaining a high level of security and performance over time.

The computer-implemented method may further include reassigning a third device in the network slice that does not comply with the intermittently updated slice configurations and security policies to another compliant slice.

This feature ensures that devices within a network slice consistently meet the required security standards, maintaining the integrity and security of each slice by relocating non-compliant devices.

The computer-implemented method may further include logging slice changes of the third device on a blockchain.

Logging slice changes on a blockchain provides an immutable and transparent record of device movements between slices, enhancing accountability and enabling better tracking of device behavior and network management decisions.

The computer-implemented method may be executed by a computational system based on code downloaded to the computational system from a remote data processing system, and may further include metering usage of the code and generating an invoice based on metering the usage of the code.

This feature allows for flexible deployment of the method across different systems while providing a mechanism for usage-based billing, potentially making the technology more accessible to a wider range of users or organizations.

In a second aspect, a system is provided. The system includes one or more processors and one or more computer readable storage media storing program instructions which, when executed by the one or more processors, are configured to cause the one or more processors to perform a method comprising connecting a first device to a network slice, segmenting data transmitted from the first device into distinct security categories, wherein the distinct security categories are assigned to a specific corresponding network slice that supports an associated security category, and in response to a request for inter-slice communication between the first device and a second device on a different network slice, transferring the second device on the different network slice to the network slice.

This system provides a hardware and software infrastructure for implementing the secure and efficient management of device communications across network slices, enabling organizations to deploy this technology within their existing computational environments.

The system may implement features and advantages similar to those described for the computer-implemented method of the first aspect.

In a third aspect, a computer program product is provided. The computer program product comprises one or more computer readable storage media, and program instructions collectively stored on the one or more computer readable storage media, the program instructions comprising instructions configured to cause one or more processors to perform a method comprising connecting a first device to a network slice, segmenting data transmitted from the first device into distinct security categories, wherein the distinct security categories are assigned to a specific corresponding network slice that supports an associated security category, and in response to a request for inter-slice communication between the first device and a second device on a different network slice, transferring the second device on the different network slice to the network slice.

The computer program product allows for easy distribution and deployment of the secure network slice management technology across various computational platforms, enabling widespread adoption of the technology.

The computer program product may implement features and advantages similar to those described for the computer-implemented method of the first aspect and the system of the second aspect.

In a fourth aspect, a computer-implemented method is provided. The computer-implemented method includes connecting a first device to a network slice, intermittently updating slice configurations and security policies of the network slice based on threat intelligence and network demands, determining that the first device does not comply with the intermittently updated slice configurations and security policies of the network slice, reassigning the first device to a second network slice that is compliant with the intermittently updated slice configurations and security policies of the second network slice, and logging slice changes of the first device on a blockchain.

This method provides a dynamic approach to managing device compliance within network slices, ensuring that security standards are consistently maintained across the network while providing a transparent record of device movements.

The computer-implemented method may be executed by a computational system based on code downloaded to the computational system from a remote data processing system, and may further include metering usage of the code and generating an invoice based on metering the usage of the code.

This feature allows for flexible deployment of the method across different systems while providing a mechanism for usage-based billing, potentially making the technology more accessible to a wider range of users or organizations.

The network slice may implement a hierarchical key management system, where each network slice utilizes a master key governing a series of subsidiary keys for managing specific sections or types of data within the slice.

The network slice may utilize different encryption algorithms for different security levels, such as post-quantum cryptography for ultra-security slices and AES-256 for high-security slices.

The computer-implemented method may implement AI-driven predictive key management to intelligently predict appropriate and beneficial times for key rotations and identify potential security threats that warrant immediate key revocation.

In a fifth aspect, a computer program product is provided. The computer program product comprises one or more computer readable storage media, and program instructions collectively stored on the one or more computer readable storage media, the program instructions comprising instructions configured to cause one or more processors to perform a method comprising connecting a first device to a network slice, intermittently updating slice configurations and security policies of the network slice based on threat intelligence and network demands, determining that the first device does not comply with the intermittently updated slice configurations and security policies of the network slice, reassigning the first device to a second network slice that is compliant with the intermittently updated slice configurations and security policies of the second network slice, and logging slice changes of the first device on a blockchain.

The computer program product allows for easy distribution and deployment of the dynamic network slice management and compliance technology across various computational platforms, enabling widespread adoption of the technology.

The computer program product may implement features and advantages similar to those described for the computer-implemented method of the fourth aspect.

The present disclosure relates to systems and methods for dynamic Internet of Things (IoT) security management on network slices (e.g., 5G network slices). Although the following disclosure discusses aspects of the present disclosure as applied to the 5G network for ease of discussion, aspects of the present disclosure are applicable to any number of networks, now known or later developed, that utilize network slices. Aspects of the present disclosure address the complexities and security challenges associated with the increased connectivity and diverse requirements of IoT devices within a network ecosystem. By leveraging dynamic management of network slices, aspects of the present disclosure can ensure that IoT devices operate within a secure and efficient network framework, tailored to their specific needs.

Aspects of the present disclosure are realized through several implementations, each contributing to the robust management of IoT security across network slices. Through these implementations, aspects of the present disclosure can provide a flexible, scalable, and secure framework for managing IoT devices on networks such as the 5G network, thereby enhancing the reliability and efficiency of these networks in supporting a wide range of IoT applications.

In some cases, the dynamic network slice generation process may begin when a device attempts to connect to a network. The process may involve several steps to ensure the device is properly authenticated and assigned to an appropriate network slice.

The first step in the process may involve device authentication. When a device attempts to connect to the network, the network may use multi-factor authentication to verify the device's identity and authorization. This authentication process may help prevent unauthorized devices from accessing the network and potentially compromising security.

After authentication, the network may evaluate the device's requirements. This evaluation may consider various factors, including the device type, resource allocation requirements, security risk profile, and security protocols currently configured for existing network slices. The network may analyze these factors to determine which existing slice, if any, is most suitable for the device.

In some cases, the network may connect the device to a network slice that satisfies bandwidth, latency, and security level requirements derived from the device characteristics. For example, a high-definition video streaming device may require a slice with high bandwidth and low latency, while a simple sensor may need a slice with lower bandwidth but higher security.

If no existing slice meets the requirements for safe and secure device connectivity, the network may create a new isolated tailored slice to meet the specific requirements of the device. This dynamic slice creation may allow the network to accommodate a wide range of device types and requirements without compromising security or performance for other devices.

To facilitate efficient management of devices across network slices, aspects of the present disclosure may create and maintain a hash table for fast device location and retrieval. This hash table may store information about each device's current network slice assignment, allowing for quick lookup and access to device information when needed.

For example, consider an industrial IoT sensor connecting to a network utilizing network slices. The network may authenticate the sensor using its unique identifier and digital certificate. Upon evaluation, the network may determine that the sensor requires low bandwidth but high security due to the sensitive nature of the data it transmits. If no existing slice meets these specific requirements, the network may create a new slice tailored for industrial sensors with similar needs. The sensor's information, including its assigned slice, may then be added to the hash table for future reference.

In another example, a consumer smartwatch may attempt to connect to a network. After authentication, the network may evaluate the device and determine that it requires moderate bandwidth and latency for real-time health monitoring. The network may find an existing slice that meets these requirements and connect the smartwatch to that slice. The device's information and slice assignment may be added to the hash table for quick access.

By implementing this dynamic network slice generation process, the network (e.g., 5G network) may efficiently manage a diverse range of IoT devices, ensuring each device operates within a network environment optimized for its specific needs and security requirements.

In some cases, aspects of the present disclosure may implement dynamic IoT network slice assignment and traceability to manage devices based on changing configurations and security policies. This process may involve several steps to ensure adequate and compliant security and performance for connected devices.

For example, aspects of the present disclosure may intermittently update slice configurations and security policies based on threat intelligence and network demands. These updates may reflect evolving security threats, changes in network traffic patterns, and/or new regulatory requirements.

After updating slice configurations and security policies, aspects of the present disclosure may perform device compliance checks. These checks may evaluate whether devices currently connected to a network slice still meet the updated security and operational requirements of that slice.

In some cases, aspects of the present disclosure may segment data transmitted from devices into distinct security categories. Each security category may be assigned to a specific corresponding network slice that supports the associated security requirements. For example, highly sensitive data may be assigned to a slice with enhanced encryption and access controls, while less sensitive data may be assigned to a slice with standard security measures.

If a device is found to be non-compliant with the updated slice configurations or security policies, aspects of the present disclosure may initiate a reassignment procedure. This procedure may involve identifying a more suitable network slice for the device based on its current characteristics and security requirements.

Aspects of the present disclosure may then transfer the non-compliant device to the identified compliant slice. This transfer may involve updating the device's network connection parameters and adjusting its access permissions to align with the new slice's configuration.

To maintain a transparent and immutable record of these changes, aspects of the present disclosure may log slice changes on a blockchain. This blockchain logging may include details such as the device identifier, the original slice, the new slice, the reason for the change, and a timestamp.

In some embodiments, the blockchain logging may be applied to all devices undergoing slice changes. For example, when a first device is reassigned to a new slice due to security policy updates, aspects of the present disclosure may log this change on the blockchain. Similarly, if a third device in a network slice becomes non-compliant with updated configurations and is reassigned, this change may also be recorded on the blockchain.

The use of blockchain for logging slice changes may provide several benefits. For one, it can create a tamper-resistant audit trail of all slice assignments and reassignments, which may be useful for security audits, regulatory compliance, and troubleshooting network issues. Additionally, the decentralized nature of blockchain may also enhance the reliability and availability of this historical data.

By implementing aspects of the present disclosure directed toward dynamic IoT network slice assignment and traceability, networks (e.g., 5G networks) may maintain adequate and compliant security and performance even as network conditions and device requirements change over time. Aspects of the present disclosure may ensure that devices are consistently operating within network slices that meet their current security and operational needs, while maintaining a comprehensive record of all changes for accountability and analysis.

In some cases, aspects of the present disclosure may implement dynamic resource allocation to optimize the utilization of network resources across network slices. This process may involve monitoring of resource usage, adjustments based on device connections and disconnections, and the transfer of devices between slices for beneficial resource distribution.

Aspects of the present disclosure may continuously, semi-continuously, and/or intermittently monitor resource usage across all network slices. This monitoring may include tracking bandwidth consumption, processing power utilization, and storage capacity for each slice. By maintaining real-time awareness of resource allocation, aspects of the present disclosure may identify opportunities for optimization and potential bottlenecks.

When a new device connects to the network, aspects of the present disclosure may assess the device's resource requirements and current resource availability across existing slices. Based on this assessment, aspects of the present disclosure may allocate resources to the device from the most suitable slice or create a new slice if necessary.

Conversely, when a device disconnects from the network, aspects of the present disclosure may reclaim the resources previously allocated to that device. These reclaimed resources may then be redistributed to other devices or held in reserve for future allocation.

In some cases, aspects of the present disclosure may transfer devices between slices to optimize resource utilization. For example, if a device's resource needs change over time, or if a more suitable slice becomes available, aspects of the present disclosure may initiate a transfer process. This transfer may involve moving the device's network connection and associated data to the new slice while ensuring continuity of service.

Aspects of the present disclosure may also respond to requests for inter-slice communication by transferring devices to the same slice when appropriate. For instance, if a first device on one slice requests communication with a second device on a different slice, aspects of the present disclosure may evaluate the resource requirements and security policies of both devices. If compatible, aspects of the present disclosure may transfer the second device to the slice of the first device, allowing direct communication while maintaining beneficial resource allocation.

In cases where slice configurations and security policies are intermittently updated, aspects of the present disclosure may reassess device compliance. If a device is found to be non-compliant with its current slice's updated policies, aspects of the present disclosure may identify a second slice that meets the device's requirements and is compliant with the updated policies. Aspects of the present disclosure may then reassign the device to this second slice, ensuring both policy compliance and efficient resource utilization.

By implementing this dynamic resource allocation approach, aspects of the present disclosure may maintain adequate and/or compliant performance across the network, adapt to changing device needs, and ensure efficient utilization of available resources while adhering to security policies and slice configurations.

In some cases, aspects of the present disclosure may implement dynamic policy control mechanisms to continuously monitor device activity and adjust security protocols in real-time. This dynamic approach may help maintain adequate and/or compliant security across the network while adapting to changing threats and device behaviors.

Aspects of the present disclosure may continuously monitor all device activity within network slices to detect abnormal behavior or potential security threats. This monitoring may involve analyzing traffic patterns, communication protocols, and device attributes to identify any deviations from expected behavior.

Based on the results of this continuous monitoring, aspects of the present disclosure may dynamically adjust security protocols and configurations. For example, if unusual traffic patterns are detected from a particular device, aspects of the present disclosure may increase encryption levels or implement additional authentication measures for that device.

In some cases, aspects of the present disclosure may implement a hierarchical key management framework for each network slice. This framework may utilize a master key for each network slice, which governs a series of subsidiary keys that manage specific sections or types of data within the slice. This structure may enhance security by isolating key management within each slice and simplify the process of key updates and revocation.

Aspects of the present disclosure may intermittently update slice configurations and security policies based on threat intelligence and network demands. These updates may reflect evolving security threats, changes in network traffic patterns, or new regulatory requirements. For example, if a new type of cyberattack is identified, aspects of the present disclosure may update security protocols across relevant slices to mitigate this threat.

After updating slice configurations and security policies, aspects of the present disclosure may perform device compliance checks. These checks may evaluate whether devices currently connected to a network slice still meet the updated security and operational requirements of that slice.

In some cases, aspects of the present disclosure may determine that a device does not comply with the intermittently updated slice configurations and security policies of its current network slice. This determination may be based on factors such as the device's current security settings, its behavior patterns, and/or its resource usage.

If a device is found to be non-compliant, aspects of the present disclosure may reassign the device to another slice that is compliant with the updated configurations and policies. This reassignment may involve identifying a suitable slice that meets the device's operational requirements while also satisfying the updated security standards.

Aspects of the present disclosure may implement rigorous verification processes for devices before allowing access to high-value slices. This verification may involve multi-factor authentication, analysis of the device's historical behavior, and/or assessment of its current security posture. Only devices that pass this verification process may be granted access to slices containing sensitive data or critical resources.

In some cases, aspects of the present disclosure may design key management protocols to be inherently compliant with data protection regulations such as General Data Protection Regulation (GDPR), the Health Insurance Portability and Accountability Act (HIPAA), and/or other data protection regulations now known or later developed. This approach may ensure that encryption key management practices automatically align with legal requirements, reducing the risk of non-compliance and simplifying regulatory audits.

By implementing these dynamic policy control mechanisms, aspects of the present disclosure may maintain a high level of security across the network while adapting to changing threats and device behaviors. This approach may help ensure that each device operates within a network environment that meets its specific security and operational needs while also protecting the overall integrity of the network.

In some cases, aspects of the present disclosure may implement continuous connection monitoring to detect and respond to potential security risks within the network slices. This process may involve several components working together to maintain the security and integrity of the network.

Aspects of the present disclosure may continuously monitor device activity within network slices to detect abnormal behavior. This monitoring may involve analyzing various aspects of device communication, including traffic patterns, data transfer rates, and/or connection frequencies. By establishing baseline behaviors for different types of devices, aspects of the present disclosure may identify deviations that could indicate potential security threats.

In some cases, aspects of the present disclosure may employ device profiling techniques to create unique identifiers for each connected device. These profiles may include information such as hardware specifications, software configurations, and/or typical usage patterns. By maintaining and updating these profiles over time, aspects of the present disclosure may more accurately detect when a device begins to exhibit unusual behavior.

Aspects of the present disclosure may utilize behavior analysis algorithms to evaluate device actions in real-time. These algorithms may compare current device behavior against historical data and expected patterns for similar devices. For example, if a smart thermostat suddenly begins transmitting large amounts of data and/or attempting to connect to unusual network resources, aspects of the present disclosure may flag this as potentially suspicious activity.

In some cases, aspects of the present disclosure may implement AI-driven predictive key management for proactive security measures. This approach may use machine learning algorithms to analyze patterns in key usage, network traffic, and/or known security threats. Based on this analysis, aspects of the present disclosure may predict appropriate times for key rotations and/or identify potential security vulnerabilities before they can be exploited.

The AI-driven system may also adapt its security measures based on the evolving threat landscape. For instance, if the AI-driven system detects an increase in certain types of attacks across the network, it may proactively strengthen encryption protocols or increase the frequency of key rotations for vulnerable devices or slices.

In some cases, aspects of the present disclosure may implement multi-factor authentication for key access in network slices. This additional layer of security may help prevent unauthorized access to sensitive network resources, even if a device or user's primary credentials are compromised. The multi-factor authentication process may involve a combination of factors such as device-specific tokens, biometric data, and/or time-based one-time passwords.

When aspects of the present disclosure detect anomalous behavior or potential security risks, it may respond in various ways depending on the nature and severity of the threat. For example, if a device exhibits minor deviations from its expected behavior, aspects of the present disclosure may increase monitoring of that device and log the anomalies for further analysis. In cases of more significant or persistent anomalies, aspects of the present disclosure may take more active measures.

In some cases, aspects of the present disclosure may temporarily isolate a suspicious device by restricting its access to certain network resources or moving it to a quarantine slice for further investigation. This isolation may help prevent potential threats from spreading to other devices or compromising sensitive data within the network.

Aspects of the present disclosure may also trigger alerts to network administrators or security personnel when significant anomalies are detected. These alerts may include detailed information about the suspicious activity, allowing human operators to make informed decisions about how to respond to potential threats.

In cases where it is determined that a device has been compromised or poses a significant security risk, aspects of the present disclosure may initiate more drastic measures. These measures may include completely disconnecting the device from the network, revoking its access credentials, and/or triggering a remote wipe of sensitive data stored on the device.

By implementing these continuous connection monitoring processes, aspects of the present disclosure may maintain a high level of security across the network slices while adapting to evolving threats and changing device behaviors. This approach may help ensure the integrity and reliability of the network for all connected devices and users.

In some cases, aspects of the present disclosure may implement multi-device communication management to ensure secure and efficient communication between devices across different network slices. This approach may involve several components and protocols to maintain security while enabling necessary inter-slice communication.

Aspects of the present disclosure may implement a multi-layer encryption strategy with different levels for different slices. This strategy may involve applying varying degrees of encryption based on the security requirements of each slice. For example, slices handling less sensitive data may use standard encryption protocols, while those dealing with highly sensitive information may employ more robust encryption methods.

In some cases, aspects of the present disclosure may use post-quantum cryptography for ultra-security slices. This advanced encryption method may be designed to resist potential attacks from quantum computers, providing an additional layer of security for the most sensitive data and communications. Post-quantum cryptography may be particularly important for slices handling long-term sensitive information that needs to remain secure even in the face of future technological advancements.

In some cases, aspects of the present disclosure may require devices to meet certain security criteria before allowing inter-slice communication. This may involve verifying the device's authentication status, checking its compliance with current security policies, and/or assessing its behavior patterns for any anomalies.

If the security requirements for inter-slice communication are met, aspects of the present disclosure may establish a secure communication channel between the devices. This channel may use encryption methods that satisfy the security requirements of both slices involved in the communication.

In cases where direct inter-slice communication is not feasible due to security constraints, aspects of the present disclosure may implement a transfer procedure to move one of the devices to the same slice as the other. This transfer may involve several steps to ensure security is maintained throughout the process.

Before initiating a device transfer, aspects of the present disclosure may perform a thorough security check on the device to be transferred. This check may include verifying the device's identity, assessing its current security status, and/or ensuring it meets the security requirements of the destination slice.

If the device passes the security check, aspects of the present disclosure may begin the transfer process. This may involve temporarily isolating the device from its current slice, updating its network parameters to align with the new slice, and gradually integrating it into the new network environment.

Throughout the transfer process, aspects of the present disclosure may maintain continuous monitoring of the device to detect any unusual behavior and/or security anomalies. If any issues are detected, aspects of the present disclosure may pause or terminate the transfer and take appropriate security measures.

Once the device transfer is complete, aspects of the present disclosure may update its records to reflect the new slice assignment. This may include updating the device's profile in a database or blockchain and adjusting any relevant access controls or security policies.

By implementing these multi-device communication management protocols, aspects of the present disclosure may maintain a high level of security while enabling necessary communication between devices across different network slices. This approach may help balance the need for secure isolation of network resources with the operational requirements of interconnected devices in a complex network environment such as the 5G network ecosystem.

In some cases, aspects of the present disclosure may implement cryptocurrency micropayment transactions for data transfer between devices on the network slices. This implementation may involve several steps to evaluate data value, generate smart contracts, and handle potential security incidents.

Aspects of the present disclosure may evaluate the type of IoT device and the value of data being sent over the network. This evaluation may consider factors such as data sensitivity, volume, and/or potential commercial value. In some cases, data senders may provide their own valuation data and requirements, including security requirements, communication protocols, and/or resource allocation needs.

Based on this evaluation, aspects of the present disclosure may generate a cryptocurrency smart contract associated with the data payload. This smart contract may include details such as the agreed-upon value of the data, the security requirements for its transfer, and the conditions for successful completion of the transaction.

Aspects of the present disclosure may use blockchain technology for decentralized key generation related to these smart contracts. This approach may enhance security by distributing the key generation process across multiple nodes in the network, reducing the risk of a single point of failure or compromise.

When initiating a data transfer, aspects of the present disclosure may associate the generated smart contract with the data payload. The contract may specify the cryptocurrency payment to be made upon successful and secure delivery of the data to the recipient. This payment may include the agreed-upon value of the data plus a predetermined processing fee for the network resources used during the transfer.

In some cases, aspects of the present disclosure may implement an insurance policy for data safety. This policy may provide additional protection and compensation in case of a data breach or security incident during transfer. The terms of this insurance policy may be included in the smart contract.

If a compromise of the IoT device connection and/or a data breach during transfer is detected, it may trigger a breach of contract scenario. In such cases, aspects of the present disclosure may revert any cryptocurrency payments processed as part of the smart contract. The data sender may receive a refund of the data security payment.

Additionally, if an insurance policy is in place, aspects of the present disclosure may initiate a claim process to compensate the data sender for the breach. The amount of compensation may be determined based on the pre-agreed terms in the smart contract and the nature of the security incident.

By implementing these cryptocurrency micropayment transactions, aspects of the present disclosure may provide a secure and transparent method for managing data transfers between devices on network slices. This approach may incentivize secure data sharing and transfer within the network while offering protection and compensation mechanisms in case of security incidents.

In some cases, aspects of the present disclosure directed toward dynamic IoT security management on network slices may be implemented through a distributed architecture, where program instructions are downloaded to one or more computer readable storage media from a remote data processing system. This approach may allow for flexible deployment and updates of the security management system across various network environments.

The computational system executing the method may operate based on code downloaded from the remote data processing system. This downloaded code may contain the instructions necessary for implementing the various features of the dynamic IoT security management system, including network slice generation, device monitoring, security policy enforcement, and/or resource allocation.

Aspects of the present disclosure may implement usage metering for the downloaded code. This metering may track various aspects of system usage, such as the number of devices managed, the volume of data processed, or the number of security incidents handled. By monitoring these metrics, aspects of the present disclosure may provide detailed insights into the utilization of the security management services.

Based on the metered usage data, aspects of the present disclosure may generate invoices for the use of the dynamic IoT security management services. These invoices may reflect the actual usage of aspects of the present disclosure, allowing for a fair and transparent billing process. This usage-based billing model may make the technology more accessible to a wider range of users or organizations, as they may only pay for the resources and services they actually consume.

In some cases, aspects of the present disclosure may additionally provide Key Management as a Service (KMaaS) integrated with the network slicing infrastructure. KMaaS may offer scalable and secure key management solutions custom-designed for varying organizational needs. This service may facilitate seamless encryption operations across network slices, enhancing security without the overhead of maintaining specialized key management systems on-premises.

To illustrate the integrated operation of aspects of the present disclosure, consider a scenario where a large-scale IoT deployment is managed across multiple network slices. The process may begin with the network operator downloading the security management system code from a remote data processing system. This code may be installed on the operator's computational systems, providing the foundation for managing IoT security across the network.

As IoT devices connect to the network, aspects of the present disclosure may dynamically assign them to appropriate network slices based on their security requirements and operational needs. Aspects of the present disclosure may generate and manage encryption keys for each slice, thereby providing KMaaS and ensuring secure communication within and between slices as needed.

Throughout the operation, aspects of the present disclosure may continuously monitor device behavior, adjust security policies, and optimize resource allocation across the network slices. If a security threat is detected, aspects of the present disclosure may automatically respond by isolating affected devices, updating security protocols, or reassigning devices to more secure slices.

Aspects of the present disclosure may track all these activities, recording metrics such as the number of devices managed, the frequency of security policy updates, and the volume of data transferred securely. At regular intervals, aspects of the present disclosure may generate invoices based on this metered usage, providing a detailed breakdown of the security management services utilized.

By integrating these various components—from code deployment to key management, continuous monitoring, and usage-based billing—aspects of the present disclosure may provide a comprehensive, flexible, and cost-effective solution for dynamic IoT security management on network slices. This integrated approach may allow network operators to maintain high levels of security across diverse IoT deployments while efficiently managing resources and costs.

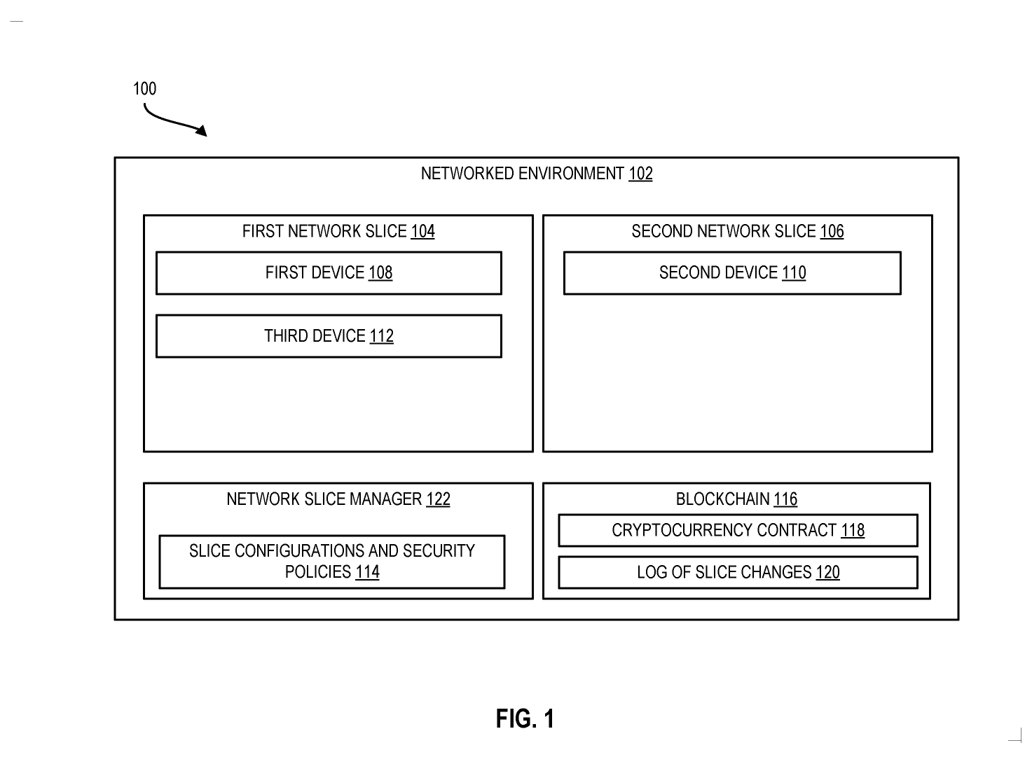

Referring now to the figures, FIG. 1 illustrates a block diagram of an example computational environment 100 for network slice management, in accordance with some embodiments of the present disclosure. Computational environment 100 can include a networked environment 102 including multiple components that can be permanently, semi-permanently, and/or intermittently connected to one another via one or more networks. Networked environment 102 includes a first network slice 104 and a second network slice 106. The first network slice 104 and the second network slice 106 can be, for example 5G network slices. More specifically, in some embodiments, the first network slice 104 and the second network slice 106 can represent two network slices in a network architecture configured to enable multiplexing of virtualized, independent logical networks on a same physical network infrastructure. In this way, the first network slice 104 and the second network slice 106 can each be isolated, end-to-end networks that have tailored performance, security, and/or other configurations suitable for satisfying a set of predefined requirements and/or implementing a set of predefined tasks.

The first network slice 104 can have first device 108 and/or third device 112 residing thereon, while the second network slice 106 can have a second device 110 residing thereon. The first device 108, second device 110, and third device 112 can be any device capable of being connected to a network implementing a network slicing architecture. For example, the first device 108, second device 110, and third device 112 can be smartphones, tablets, computers, servers, mainframes, desktops, laptops, sensors, wearables, Internet of Things (IoT) devices, appliances, vehicles, identification cards, payment cards, and the like.

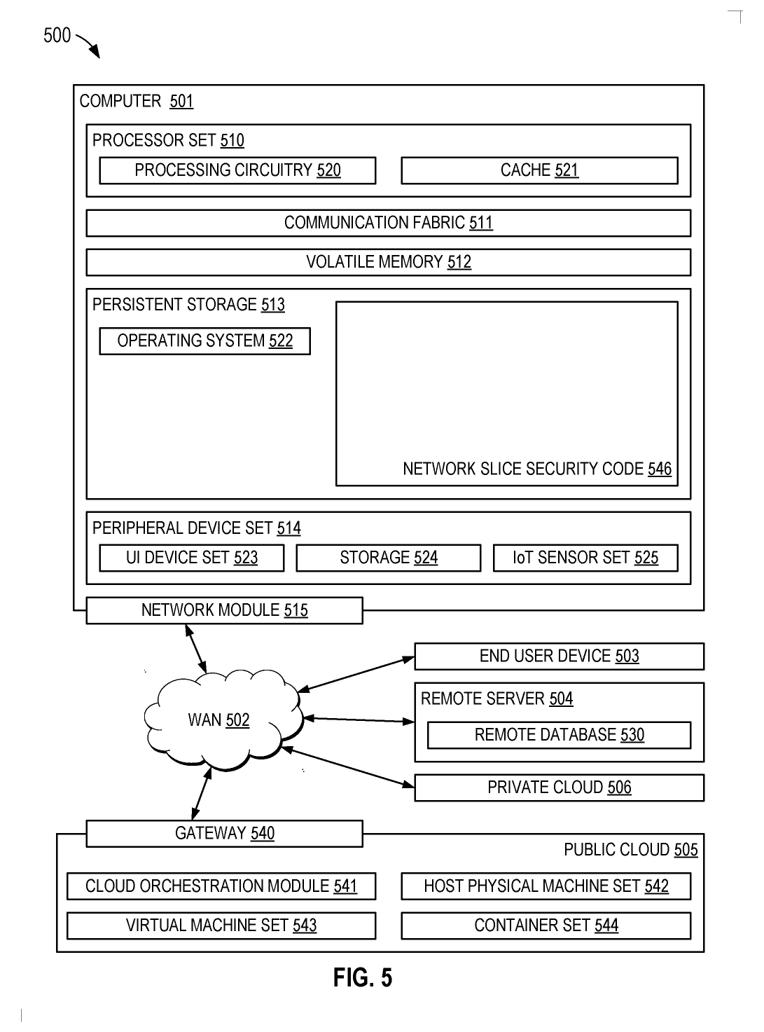

The networked environment 102 can include a network slice manager 122 that stores slice configurations and security policies 114 that define the configurations and security policies of each slice (e.g., first network slice 104 and second network slice 106). The slice configurations and security policies 114 can be intermittently updated to improve performance of various devices on various slices in the networked environment 102. Slice configurations and security policies 114 can include, among other factors, latency, bandwidth, encryption, security level, and the like. The network slice manager 122 can manage the creation and dissolution of network slices. Additionally, the network slice manager 122 can assign various devices to various network slices and/or migrate various devices to different network slices. The network slice manager 122 can be a computer (e.g., computer 501 of FIG. 5), processor, and/or another configuration of hardware and/or software suitable for implementing aspects of the present disclosure.

Networked environment 102 can further include blockchain 116. Blockchain 116 can refer to any immutable digital ledger (whether centralized or decentralized). Blockchain 116 can be used to implement a cryptocurrency contract 118 and/or record slice changes in a log of slice changes 120.

In some embodiments, first device 108 can be connected the first network slice 104. Data generated by the first device 108 can be segmented into appropriate network slices. Subsequently, a request for communication between the first device 108 and the second device 110 can be received. The second device 110 can be transferred to the first network slice 104 to enable improved security and performance in the communication between the first device 108 and the second device 110 on the first network slice 104.

In some embodiments, the slice configurations and security policies 114 are intermittently updated. In response to an intermittent update, it may be determined that the third device 112 residing on the first network slice 104 is no longer compliant with the updated slice configurations and security policies 114 associated with the first network slice 104. In response, the third device 112 can be migrated to a different, compliant network slice (e.g., second network slice 106).

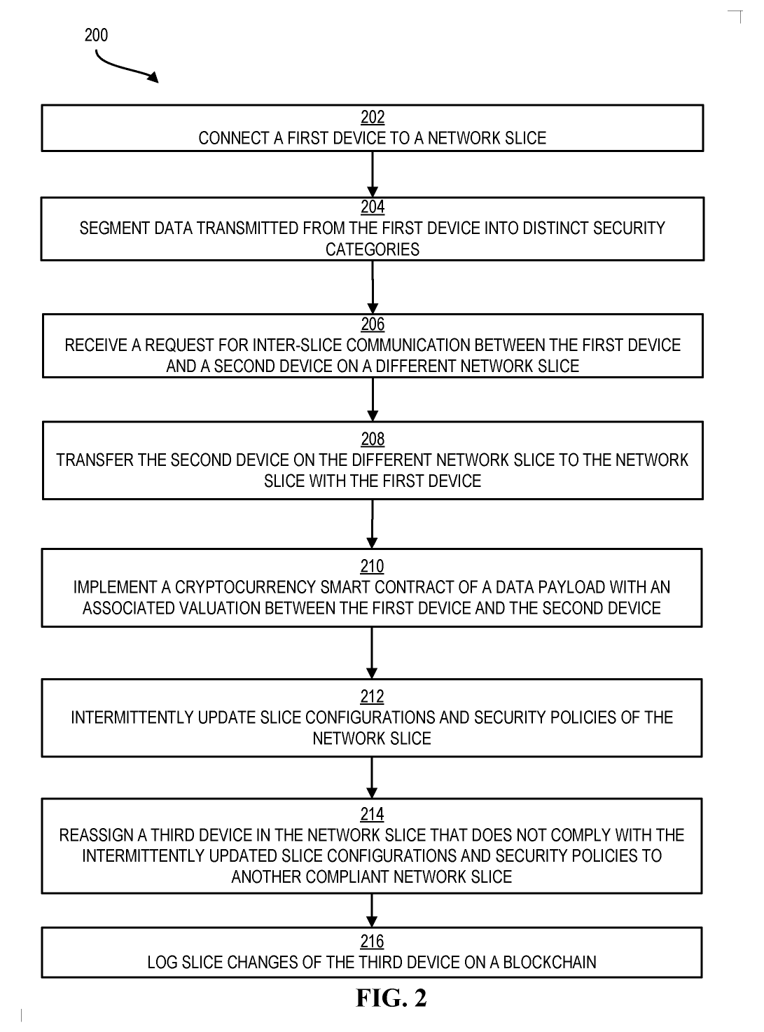

FIG. 2 illustrates a flowchart of an example method 200 for inter-slice communication and network slice management, in accordance with some embodiments of the present disclosure. The method 200 can be implemented by a computer, a processor, a network slice manager (e.g., network slice manager 122 of FIG. 1), and/or another configuration of hardware and/or software.

Operation 202 includes connecting a first device to a network slice. In some embodiments, connecting the first device to the network slice satisfies a bandwidth, latency, and/or security level requirement derived from device characteristics of the first device. At operation 204, the method 200 segments data transmitted from the first device into distinct security categories. In some embodiments, the distinct security categories are assigned to a specific corresponding network slice that supports an associated security category.

The method 200 proceeds to operation 206, where a request is received for inter-slice communication between the first device and a second device on a different network slice. Following this request, at operation 208, the method 200 transfers the second device from its different network slice to the network slice containing the first device.

At operation 210, the method 200 implements a cryptocurrency smart contract of a data payload with an associated valuation between the first device and the second device.

Operation 212 includes intermittently updating slice configurations and security policies of the network slice. Operation 214 includes reassigning a third device in the network slice that does not comply with the intermittently updated slice configurations and security policies to another compliant slice. Finally, at operation 216, the method 200 logs slice changes of the third device on a blockchain.

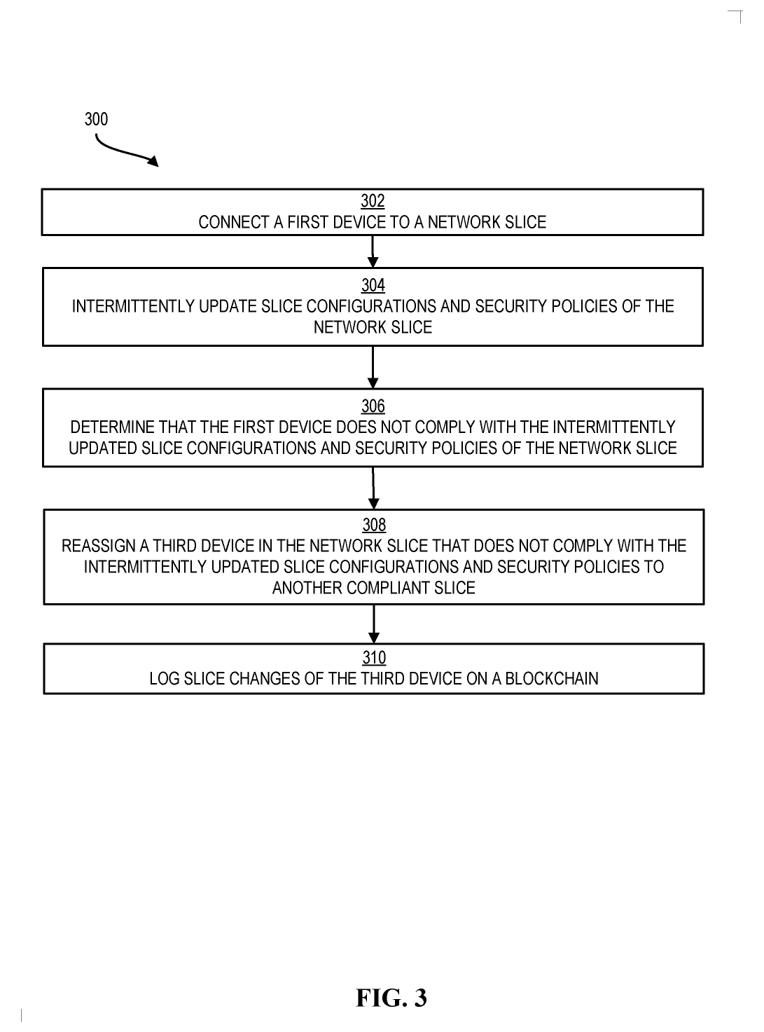

FIG. 3 illustrates a flowchart of an example method 300 for inter-slice migration and network slice management, in accordance with some embodiments of the present disclosure. The method 300 can be implemented by a computer, a processor, a network slice manager (e.g., network slice manager 122 of FIG. 1), and/or another configuration of hardware and/or software.

The method 300 begins with operation 302, where a first device is connected to a network slice. In operation 304, the method 300 intermittently updates slice configurations and security policies of the network slice. The method 300 then proceeds to operation 306, where a determination is made regarding whether the first device complies with the intermittently updated slice configurations and security policies of the network slice. Following this determination, in operation 308, the method 300 reassigns a third device in the network slice that does not comply with the intermittently updated slice configurations and security policies to another compliant slice. The method 300 concludes with operation 310, which involves logging slice changes of the third device on a blockchain.

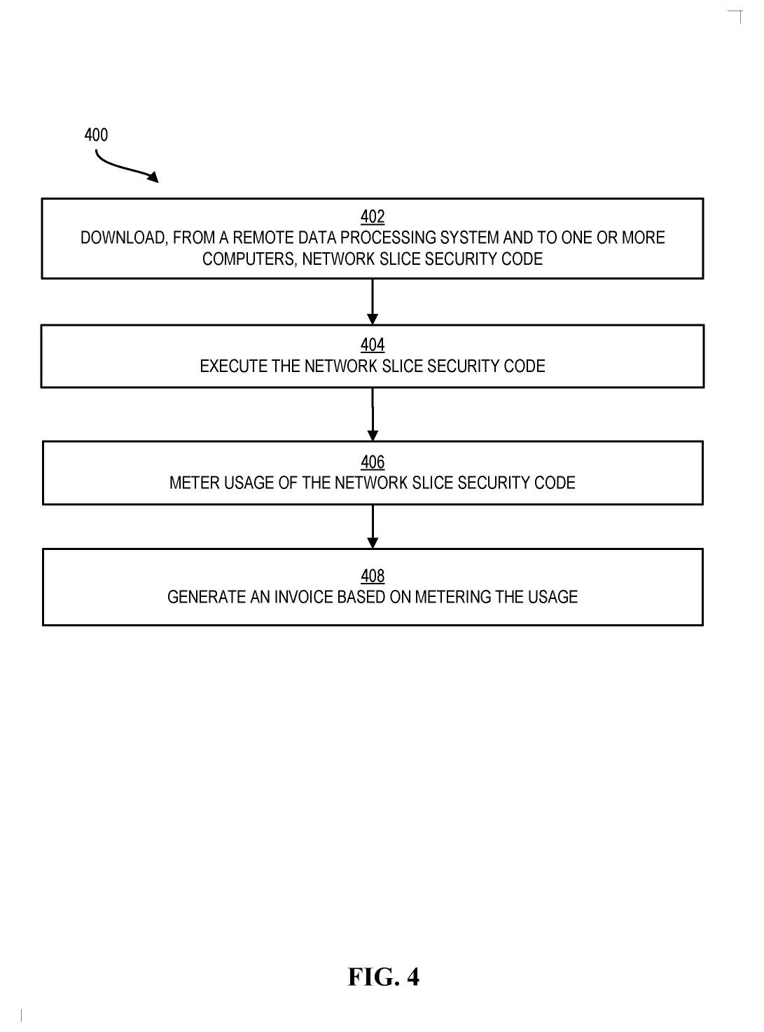

FIG. 4 illustrates a flowchart of an example method 400 for downloading, deploying, metering usage, and invoicing network slice security code 546, in accordance with some embodiments of the present disclosure. The method 400 can be implemented by a processor, a computer, a network slice manager (e.g., network slice manager 122 of FIG. 1), or any other combination of hardware and/or software. In some embodiments, the method 400 occurs before, during, and/or after any of the aforementioned methods.

Operation 402 includes downloading, from a remote data processing system and to one or more computers (e.g., network slice manager 122 of FIG. 1, computer 501 of FIG. 5, etc.) network slice security code 546. Operation 404 includes executing the network slice security code 546. The executing can include performing any of the methods and/or functionalities discussed herein. Operation 406 includes metering usage of the network slice security code 546. Usage can be metered by, for example, an amount of time the network slice security code 546 is used, a number of servers and/or devices deploying the network slice security code 546, an amount of resources consumed by implementing the network slice security code 546, a number of device assignments and/or migrations made to or between network slices implemented by execution of the network slice security code 546, and the like. Operation 408 includes generating an invoice based on metering the usage.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 5 illustrates a block diagram of an example computing environment, in accordance with some embodiments of the present disclosure. Computing environment 500 contains an example of an environment for the execution of at least some of the computer code involved in performing the inventive methods, such as Network slice security code 546. In addition to Network slice security code 546, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and Network slice security code 546, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in Network slice security code 546 in persistent storage 513.

Communication fabric 511 is the signal conduction paths that allow the various components of computer 501 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

Persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in Network slice security code 546 typically includes at least some of the computer code involved in performing the inventive methods.

Peripheral device set 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

Cloud computing services and/or microservices (not separately shown in FIG. 5): private clouds 506 and public clouds 505 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers’ code, transmit the proxy server code, and then install the proxy server code on the proxy computer. The process software will be transmitted to the proxy server, and then it will be stored on the proxy server.

Embodiments of the present disclosure can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client’s operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

What is claimed is:

1. A computer-implemented method comprising:
connecting a first device to a network slice;
segmenting data transmitted from the first device into distinct security categories, wherein the distinct security categories are assigned to a specific corresponding network slice that supports an associated security category; and
in response to a request for inter-slice communication between the first device and a second device on a different network slice, transferring the second device on the different network slice to the network slice.

2. The computer-implemented method of claim 1, further comprising:
implementing a cryptocurrency smart contract of a data payload with an associated valuation between the first device and the second device.

3. The computer-implemented method of claim 1, wherein connecting the first device to the network slice satisfies a bandwidth, latency, and security level requirement derived from device characteristics of the first device.

4. The computer-implemented method of claim 1, further comprising:
intermittently updating slice configurations and security policies of the network slice based on threat intelligence and network demands.

5. The computer-implemented method of claim 4, further comprising:
reassigning a third device in the network slice that does not comply with the intermittently updated slice configurations and security policies to another compliant slice.

6. The computer-implemented method of claim 5, further comprising:
logging slice changes of the third device on a blockchain.

7. The computer-implemented method of claim 1, wherein the computer-implemented method is executed by a computational system based on code downloaded to the computational system from a remote data processing system, and wherein the computer-implemented method further comprises:
metering usage of the code; and
generating an invoice based on metering the usage of the code.

8. A system comprising:
one or more processors; and
one or more computer readable storage media storing program instructions which, when executed by the one or more processors, are configured to cause the one or more processors to perform a method comprising:
connecting a first device to a network slice;
segmenting data transmitted from the first device into distinct security categories, wherein the distinct security categories are assigned to a specific corresponding network slice that supports an associated security category; and
in response to a request for inter-slice communication between the first device and a second device on a different network slice, transferring the second device on the different network slice to the network slice.

9. The system of claim 8, wherein the method further comprises:
implementing a cryptocurrency smart contract of a data payload with an associated valuation between the first device and the second device.

10. The system of claim 8, wherein connecting the first device to the network slice satisfies a bandwidth, latency, and security level requirement derived from device characteristics of the first device.

11. The system of claim 8, wherein the method further comprises:
intermittently updating slice configurations and security policies of the network slice based on threat intelligence and network demands.

12. The system of claim 11, wherein the method further comprises:
reassigning a third device in the network slice that does not comply with the intermittently updated slice configurations and security policies to another compliant slice.

13. The system of claim 12, wherein the method further comprises:
logging slice changes of the third device on a blockchain.

14. The system of claim 8, wherein the program instructions are downloaded to the one or more computer readable storage media from a remote data processing system, and wherein the method further comprises:
metering usage of the program instructions; and
generating an invoice based on metering the usage of the program instructions.

15. A computer program product comprising one or more computer readable storage media, and program instructions collectively stored on the one or more computer readable storage media, the program instructions comprising instructions configured to cause one or more processors to perform a method comprising:
connecting a first device to a network slice;
segmenting data transmitted from the first device into distinct security categories, wherein the distinct security categories are assigned to a specific corresponding network slice that supports an associated security category; and
in response to a request for inter-slice communication between the first device and a second device on a different network slice, transferring the second device on the different network slice to the network slice.

16. The computer program product of claim 15, wherein the method further comprises:
implementing a cryptocurrency smart contract of a data payload with an associated valuation between the first device and the second device.

17. The computer program product of claim 15, wherein connecting the first device to the network slice satisfies a bandwidth, latency, and security level requirement derived from device characteristics of the first device.

18. The computer program product of claim 15, wherein the method further comprises:
intermittently updating slice configurations and security policies of the network slice based on threat intelligence and network demands.

19. The computer program product of claim 18, wherein the method further comprises:
reassigning a third device in the network slice that does not comply with the intermittently updated slice configurations and security policies to another compliant slice.

20. The computer program product of claim 19, wherein the method further comprises:
logging slice changes of the third device on a blockchain.

21. The computer program product of claim 15, wherein the program instructions are downloaded to the one or more computer readable storage media from a remote data processing system, and wherein the method further comprises:
metering usage of the program instructions; and
generating an invoice based on metering the usage of the program instructions.

22. A computer-implemented method comprising:
connecting a first device to a network slice;
intermittently updating slice configurations and security policies of the network slice based on threat intelligence and network demands;
determining that the first device does not comply with the intermittently updated slice configurations and security policies of the network slice;
reassigning the first device to a second network slice that is compliant with the intermittently updated slice configurations and security policies of the second network slice; and
logging slice changes of the first device on a blockchain.

23. The computer-implemented method of claim 22, wherein the computer-implemented method is executed by a computational system based on code downloaded to the computational system from a remote data processing system, and wherein the computer-implemented method further comprises:
metering usage of the code; and
generating an invoice based on metering the usage of the code.

24. A computer program product comprising one or more computer readable storage media, and program instructions collectively stored on the one or more computer readable storage media, the program instructions comprising instructions configured to cause one or more processors to perform a method comprising:
connecting a first device to a network slice;
intermittently updating slice configurations and security policies of the network slice based on threat intelligence and network demands;
determining that the first device does not comply with the intermittently updated slice configurations and security policies of the network slice;
reassigning the first device to a second network slice that is compliant with the intermittently updated slice configurations and security policies of the second network slice; and
logging slice changes of the first device on a blockchain.

25. The computer program product of claim 24, wherein the program instructions are downloaded to the one or more computer readable storage media from a remote data processing system, and wherein the method further comprises:
metering usage of the program instructions; and
generating an invoice based on metering the usage of the program instructions.
